(19) United States
(12) Patent Application Publication
(10) Pub. No.: US 2021/0214093 A1
(43) Pub. Date: Jul. 15, 2021

(54) MINI-JET ENGINE, IN-FLIGHT SAFETY MEASURE

(71) Applicant: Jocelyn Bruno, Cibolo, TX (US)

(72) Inventor: Jocelyn Bruno, Cibolo, TX (US)

(21) Appl. No.: 16/744,148

(22) Filed: Jan. 15, 2020

(51) Int. Cl. B64D 27/02; B64D 41/00; B64D 31/02

(52) U.S. Cl. CPC B64D 27/02; B64D 2041/002; B64D 31/02; B64D 41/00

(57) ABSTRACT

The wearable support article contains a clamping mechanism, a support mechanism, and a wearable support. These components are combined to support an instrument, such as a viola or violin, when is it being played by a musician. The clamping mechanism provides a mechanism to attaching the article to the instrument in a manner that holds one end of the instrument in place without needing a hand of the musician. The support mechanism provides an orientation support platform upon which the clamping mechanism will be held. The wearable support provides a strap mechanism of the entire wearable support article to be worn by a musician while playing the instrument.

### TECHNICAL FIELD

This application relates in general to a system for flight safety for drones and aircraft, and more particularly, apparatus for providing redundant mini-jet engine systems for in-flight safety.

### BACKGROUND

Although in-flight engine failure is not a frequent occurrence, the severity of harm to a drone or aircraft and any passengers may be catastrophic. Continuing flight, for a least as long as necessary to reach a safe landing location, is of utmost importance. This need is especially in flights that cross large expanses of water as landing an aircraft safely onto a body of water is extremely dangerous.

Providing additional full sized engines that are used as redundant sources of thrust for an extremely low probability event may not be practical as additional full size engines significantly add weight and aerodynamic drag to an aircraft causing it to consume additional fuel for every flight that does not require use of the redundant engine.

The present invention attempts to address the existing limitations in providing additional sources of thrust during flight in sufficient amount to at least permit a flight to reach a safe landing location according to the principles and example embodiments disclosed herein.

### SUMMARY

In accordance with the present invention, the above and other problems are solved by providing additional and redundant mini-jet engines to an aircraft or drone to operate in the event of an in-flight failure of a main engine.

In one embodiment, the present invention is a backup aircraft engine apparatus for providing replacement thrust to an aircraft. The aircraft has at least one main engine and separate fuel lines with separate main fuel valves to a main fuel tank. the backup aircraft engine apparatus has one or more mini-jet engines connected to a mini-jet fuel tank through a mini-jet fuel line having a mini-jet fuel valve, a separate mini-jet fuel line and corresponding mini-jet fuel valve connecting each of the one or more mini-jet engines to the mini-jet fuel tank, a control device for setting and maintaining operating states of the main engines and the mini-jet engines during a flight, the mini-jet fuel tank for holding a fuel source independent from a main fuel tank, and a connecting fuel line having a connecting fuel valve for controlling flow of fuel between the mini-jet fuel tank and the main fuel tank.

The great utility of the invention is that a set of min-jet engines may provide an additional sources of thrust during flight in sufficient amount to at least permit a flight to reach a safe landing location even when the failure occurs while the drone or aircraft is over a large expanse of water.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates one potential embodiment a set of mini-jet engines providing an additional sources of thrust during flight according to the present invention.

FIG. 2 illustrates another potential embodiment a set of mini-jet engines providing an additional sources of thrust during flight according to the present invention.

FIG. 3 illustrates an instrument clamping arrangement for a set of mini-jet engines providing an additional sources of thrust during flight according to the present invention.

FIG. 4 is a schematic representation of some computing components of the system for use as a control device as disclosed in accordance with at least one embodiment herein.

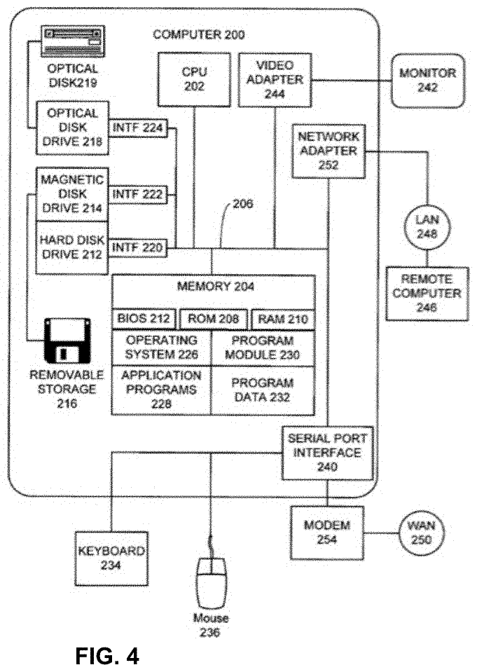

### DETAILED DESCRIPTION

This application relates in general a system ad method for providing an additional sources of thrust to aircraft and drones during flight in sufficient amount to at least permit a flight to reach a safe landing location even when the failure occurs while the drone or aircraft is over a large expanse of water.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “aircraft” refers to a jet aircraft or unmanned drone capable of flight regardless of whether a person or cargo is present within the aircraft at the time of flight. For such a system, the terms “aircraft” and “drone” may be used herein interchangeably.

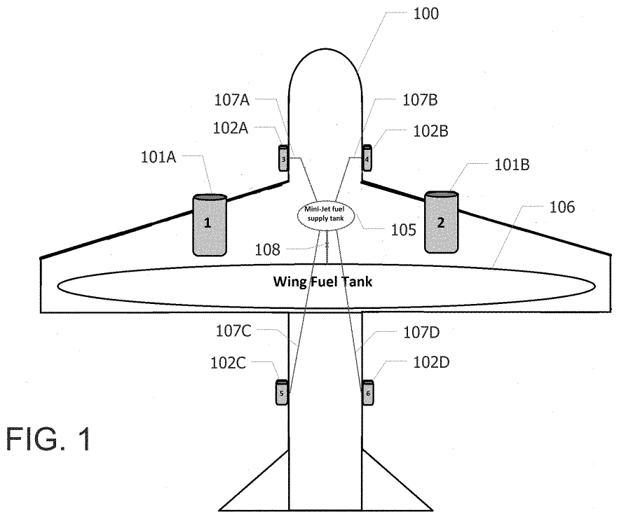

In general, the present disclosure relates general a system containing a set of mini-jet engines providing an additional sources of thrust during flight to an aircraft or a drone. To better understand the present invention, FIG. 1 represents one potential embodiment a set of mini-jet engines providing an additional sources of thrust during flight according to the present invention. In this first embodiment, aircraft 100 typically operates in flight using two main engines 101A-101B. These main engines 101A-B may be standard jet engines sized to provide an amount of thrust needed to maintain flight for an aircraft of a given size and weight at time of takeoff (including fuel). The main engines 101A-B obtain fuel for operation during flight from a wing fuel tank 106. The wing fuel tank 106 may include a single tank of fuel as well as a plurality of interconnected fuel tanks configured to fit within the inner confines of an aircraft wing. Wing fuel tank 106 may also be referred to main fuel tank interchangeably and refers to the same fuel tank. A pilot may start and stop the main engines 101A-B as needed and may stop the flow of fuel from the wing fuel tank 106 to the main engines using a set of fuel valves. The fuel valves (not shown) are located along a fuel line from the wing fuel tank 106 and the main engines 101A-B.

A set of multiple mini-engines 102A-102D may be located along the outer side of the aircraft fuselage. Each of the mini-engines 102A-102D may consist of small jet engines with sufficient thrust that the entire set maintains flight of the aircraft. Each of the mini-engines 102A-102D are also of a size that they entire set does not add significant weight and aerodynamic drag to the aircraft.

The set of mini-engines 102A-102D typically receive fuel from an independent emergency fuel tank 105. A fuel line 107A-D connects the mini-jet fuel tank 105 to each of the corresponding mini-engines 102A-102D. The mini-jet fuel tank 105 may be filled prior to flight to provide a source of fuel to the set of engines 102A-D should an emergency prevent fuel from the wing fuel tank 106 not be possible. An additional fuel line including a fuel line 108 may connect the wing fuel tank 106 and the mini-jet fuel tank 105 to provide additional fuel to the set of mini-engines 102A-D during flight. To save weight at the time of takeoff, the mini-jet fuel tank 105 may be left empty of fuel in alternate embodiments where the fuel valve 108 may be operated by a pilot to transfer fuel between the tanks as an emergency is detected. A preferred use would be to fill the emergency fuel tank 105 prior to flight to increase the likelihood that the mini-engines 102A-D may receive fuel to operate.

Main engines 101A-B receive its fuel from wing fuel tank 106 using a separate set of fuel lines having a fuel valve (not shown). During an emergency, a pilot may disable the operation of a main engine 101A and also disconnect the disabled engine from the wing fuel tank 106 using the appropriate fuel valve. Disconnecting a disabled engine 101A from the main fuel source may reduce the risk of a fire from this fuel while the engine is disabled. Disconnecting a disabled engine 101A from the wing fuel tank 106 may also prevent an unintended loss of fuel should the disabled engine receive and leak fuel into the air.

While the embodiment disclosed herein contemplates that the set of mini-engines are made using small jet turbines sizes as necessary to fit in the reduced volume along the aircraft fuselage 100, other engine technology such as electric fan engines and other technologies that provide the needed amount of thrust to the aircraft 100 within the confines of the mini-engines' enclosures.

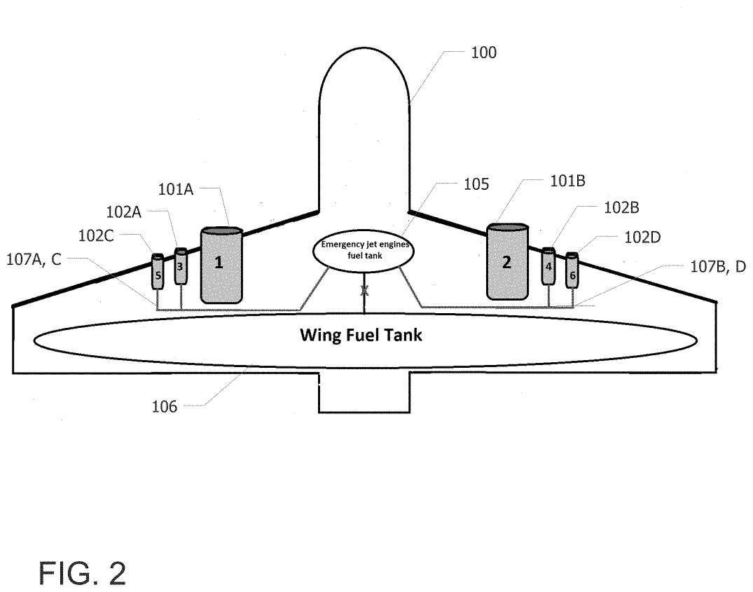

FIG. 2 illustrates another potential embodiment a set of mini-jet engines providing an additional sources of thrust during flight according to the present invention. In this second embodiment, the set of mini-engines 102A-D are located along the outward edge of each wing. Two main engines 101A-B are used during normal operation with the set of mini-engines 102A-D operating during an emergency under the command of the pilot. The various sets of engines obtain fuel in a similar manner as is described above with reference to FIG. 1. In all of these embodiments, pilots may periodically engage the set of mini-engines 102A-D during flight to keep all of moving parts therein moving and to verify operability of the mini-engines 102A-D before an emergency occurs.

Other fuel connection arrangements such as use of a single main fuel tank 106 to provide fuel to all of the engines may be used to reduce the complexity of construction and operation of the engine fuel system. The additional of additional fuel lines, fuel valves, and control electronics adds weight and consumes volume in the aircraft. Such constraints may exist when constructing smaller drone aircraft where space is at a premium. The simplicity may, however, render the additional, redundant engines ineffective during emergencies that damage the main fuel tank 106 and/or its fuel lines. Such a tradeoff between size and complexity and effectiveness of a backup engine system is made depending upon the nature of the aircraft being supported. Aircraft carrying human beings or other valuable cargo may prefer effectiveness over size. Unmanned small drones may prefer simplicity and size.

Wing mounted mini-engines may also be more appropriate if the mini-engines are not jet turbines. Research into electric engines for use in flight has led to some designed to use a larger number of fan-based engines along the entire length of a wing, or possibly integrated into the wing to obtain the needed thrust from the larger set of engines. All of these various embodiments are contemplated to be part of the present invention as defined within the attached claims.

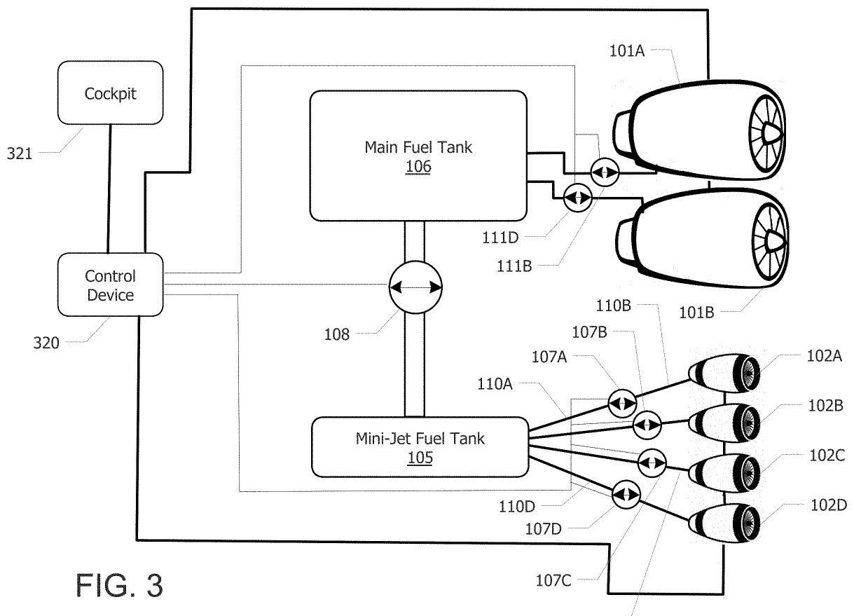

FIG. 3 illustrates an instrument clamping arrangement for a set of mini-jet engines providing an additional sources of thrust during flight according to the present invention. The operation of any of the engines on an aircraft are generated in a cockpit 321. In a manned aircraft, the pilot is flying within the aircraft. For unmanned drones, the pilot is in a remote cockpit. Both systems have input controls that instruct a control device 320 to operate the engines and related fuel supply valves.

Control device 320 is typically a software-based control system that generates electronic signals to the items being controlled to initialize, enable, and disable operation. In the case of engines, control device 320 may also adjust the amount of thrust being generated with control of an amount of fuel and rate of rotation of the turbine. All of the devices in the engine and emergency engine systems operate in response to signals from control device 320.

The main engine subsystem consists of the two main engines 101A-B, main fuel tank 106, and fuel line valves 111A-B. The emergency engine subsystem consists of the four main engines 102A-D, mini-jet fuel tank 105, and mini-jet fuel line valves 107A-D. Fuel valve 108 provides a connection between main fuel tank 106 and mini-jet fuel tank 105 for possible inflight fuel transfer as needed.

During ordinary operation of the aircraft, control device 320 sets and maintains main engines 101A-B in an operating mode and main fuel values 111A-B in an open position to provide fuel from main fuel tank 106 to the main engines. At the same time, control device 320 320 sets and maintains mini-jet engines 102A-D in a disabled mode and mini-jet fuel values 107A-D in a closed position to prevent fuel from min-jet fuel tank 205 to the mini-jet engines. Fuel valve 108 is nominally set to a closed position. The pilot may open this fuel valve 108 should a need arise to transfer fuel between tanks. Each of these fuel lines may include a fuel pump (not shown) to assist the movement of fuel from the tanks to the engines.

When an emergency condition arises that requires the shutting down of a main engine 101A, the pilot sets various switches to new positions to cause the control device 320 to send electrical signals to main engine 101A disabling the engine and to main fuel valve 111A to close the fuel valve. The pilot next may change additional switches to new positions to cause the control device 320 to send electrical signals to mini-jet engines 102A-D starting these mini-jet engines and to mini-jet fuel valves 110A-D to open each fuel valve. Signals to the mini-jet engines sent by control device 320 may include a sequence of one or more separate signals both simultaneously and/or in particular sequence to each mini-jet engine as part of a starting process to cause the turbine to spin and fuel to flow and ignite. The pilot may continue the flight as intended once the mini-jet engines 102A-D are operating.

As noted above, the use of a set of mini-jet engines 102A-D in place of one or more main engines 101A-B may be to complete a flight as planned. This flight option requires that the total thrust generated by the set of mini-jet engines be equivalent to the amount of thrust needed to replace a main engine 101A. Depending upon the particular mini engine used, the total weight of the aircraft, and the distance still to be travelled, this flight option to continue to an intended destination many or may not be feasible. An alternate flight option may include continuing the flight to a closest safe landing facility. The particular circumstances at the time of an emergency caused by a main engine failure will dictate the flight option choice.

FIG. 20 illustrates a computer system 200 adapted according to certain embodiments of the control device 320. The central processing unit (“CPU”) 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of computer system 200. Rather the computer system 200 is provided as an example of one type of computing device that may be adapted to perform the functions of a control device 320 as shown in FIG. 3. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A backup aircraft engine apparatus for providing replacement thrust to an aircraft having at least one main engine and separate fuel lines with separate main fuel valves to a main fuel tank upon shutdown of the at least one main engine, the backup aircraft engine apparatus comprises:
one or more mini-jet engines connected to a mini-jet fuel tank through a mini-jet fuel line having a mini-jet fuel valve, a separate mini-jet fuel line and corresponding mini-jet fuel valve connecting each of the one or more mini-jet engines to the mini-jet fuel tank;
a control device for setting and maintaining operating states of the main engines and the mini-jet engines during a flight;
the mini-jet fuel tank for holding a fuel source independent from a main fuel tank; and
a connecting fuel line having a connecting fuel valve for controlling flow of fuel between the mini-jet fuel tank and the main fuel tank.

2. The backup aircraft engine apparatus according to claim 1, wherein combined thrust generated by the one or more mini-jet engines is equivalent to a nominal operating thrust of one main engine.

3. The backup aircraft engine apparatus according to claim 1, wherein the mini-jet fuel tank is full of fuel at the time of takeoff of the aircraft.

4. The backup aircraft engine apparatus according to claim 1, wherein the connecting fuel is opened upon receipt of an electronic signal from the control device causing fuel to flow between the main full tank and the mini-jet fuel tank.

5. The backup aircraft engine apparatus according to claim 1, wherein the one or more mini-jet engines are mounted upon an outer side of a fuselage of the aircraft.

6. The backup aircraft engine apparatus according to claim 1, wherein the one or more mini-jet engines are mounted upon wings of the aircraft.

7. The backup aircraft engine apparatus according to claim 5, wherein each of the one or more mini-jet engines is a turbine-based jet engine.

8. The backup aircraft engine apparatus according to claim 1, wherein each of the one or more mini-jet engines is an electric fan-based engine.

9. The backup aircraft engine apparatus according to claim 1, wherein the aircraft is a manned aircraft operated by the pilot.

10. The backup aircraft engine apparatus according to claim 1, wherein the aircraft is an unmanned drone remotely operated by the pilot.
